(19) United States
(12) Patent Application Publication
(10) Pub. No.: US 2008/0023302 A1
(43) Pub. Date: Jan. 31, 2008

(54) Conveyor system with dynamic gapping and method of slug building

(75) Inventor: Christopher W. Groom, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Dematic Corp., Grand Rapids, MI (US)

(21) Appl. No.: 11/825,757

(22) Filed: Jul. 9, 2007

Related U.S. Application Data
(60) Provisional application No. 60/806,865, filed on Jul. 10, 2006.

(51) Int. Cl. B65G 13/07

(52) U.S. Cl. 198/781.06

(57) ABSTRACT

A slug-building conveyor system and method includes providing a conveying surface defined by a plurality of tandem zones, each of said zones including an article sensor and a position encoder. The encoder produces a position signal proportional to movement of articles in that zone. The article sensor senses articles in that zone. A target position is set for an article in a zone as a function of a position of an article downstream of that article in the direction of article flow. The speed of that zone is adjusted to bring the article toward its target position such that gaps between articles are adjusted during transportation of the articles.

### CROSS REFERENCE TO RELATED APPLICATION

This application claims priority from U.S. provisional patent application Ser. No. 60/806,865, filed on Jul. 10, 2006, the disclosure of which is hereby incorporated herein by reference in its entirety.

### BACKGROUND OF THE INVENTION

This invention is directed to a method of building slugs in a transport conveyor system. The invention is particularly useful with systems for conveying articles, also referred to as “parcels,” but may be used with the transportation of other items.

In conveyor systems, it is desirable to transport articles with as small a gap as possible between the articles in order to increase the throughput, namely, the number of articles transported in a given period of time. This is often accomplished by the provision of specialized equipment known as “accumulators.” Such accumulators, for example, may be provided downstream of a pick operation. The articles coming out of the pick operation may be accumulated into a slug and then transported throughout the rest of the system as a slug. It is also known to provide accumulators upstream of a sortation operation. Such accumulators are often long in length and involve the provision of specialized equipment. During accumulation, or slug-building, downstream articles are stopped and articles are allowed to accumulate behind the downstream articles in order to build a slug. The articles may be discharged once they have been accumulated.

The difficulty with known slug-building operations is that they involve the provision of specialized equipment, which is typically more costly and complex than transportation conveyors. Moreover, they are relatively inflexible and typically operate in a particular accumulation mode of operation and one or more discharge modes of operation with gaps between the articles that are established by the physical parameters of the accumulation equipment. Moreover, the accumulation of articles involves the stopping of the articles.

### SUMMARY OF THE INVENTION

The present invention is directed to a slug-building conveyor system and method of conveying articles that overcomes the difficulties of known systems. In particular, the invention provides the ability to dynamically gap articles that are being transported between operations. The gapping is dynamic in that it may be set or modified through the control system in order to produce any desired gap between the articles, including no gap. Also, the articles may be accumulated utilizing transport conveyors, such as belt conveyors, and may be accumulated without the necessity for stopping the conveyors. Moreover, according to certain aspects of the invention, the system and method may allow for the dynamic gapping of articles, notwithstanding the removal of one or more articles from the conveyor system. Also, the dynamic gapping may be accomplished even for articles that are significantly smaller than a zone or larger than one zone.

A slug-building conveyor system and method of building slugs of articles according to an aspect of the invention includes providing a conveying surface defined by a plurality of tandem zones, each of these zones including an article sensor and a position encoder. A position signal is produced with the position encoder. The position signal is proportional to movement of articles in that zone. Articles are sensed in a zone with the article sensor. A control is provided that is responsive to the position signals and to the article sensors for tracking articles in said zones. A target position is established for an article in one of the zones as a function of a position of an article downstream of that article in the direction of article flow. The speed of the one of the zones is adjusted to bring that article toward its target position. In this manner, gaps between articles may be adjusted during transportation of the articles.

Each of said zones may include an endless belt and a motor driven roller, said motor driven roller driving said belt. The endless belt may define a portion of said conveying surface. The position signal may be proportional to movement of the belt in that zone. The control may be adapted to control the speed of at least one of the belts to bring an article to its target position as it travels through the corresponding zone.

The gaps between articles may be pitch gaps, window gaps and/or configurable gaps. The control defines a data set for each article on said conveying surface. The control may be adapted to delete the data set for an article when that article does not arrive at a zone within an anticipated interval. The data set may include i) article weight, ii) article width, iii) article identification, iv) barcode, and/or v) radio frequency identification code.

The motor driven roller may be a motorized roller. The motor driven roller may define the encoder. The motorized roller may include rotational position sensors used for application of electrical power to rotate the motorized roller and the control may obtain the position signal from the rotational position sensors.

A slug-building conveyor system and method of building slugs of articles according to another aspect of the invention includes providing a conveying surface defined by a plurality of tandem zones, each of the zones including an article sensor and a position encoder. A position signal is provided with the position encoder. The position signal is proportional to movement of articles in that zone. A control is provided that is responsive to the position signals and to the article sensors for tracking articles in the zones. The control is adapted to determine anticipated positions sensing articles in a zone as a function of at least one of the position signals. An anticipated arrival of an article at one of the zones is determined as a function of the anticipated position of that article. An actual arrival of that article at that zone is determined as a function of the article sensor for that zone sensing that article. The actual arrival of that article at the zone is compared with the anticipated arrival of that article at that zone. The anticipated position of that article is updated as a function of the comparing. A target position for that article is established as a function of a position of an article downstream of that article in the direction of article flow. The speed of that zone is adjusted to bring that article toward its target position.

These and other objects, advantages and features of this invention will become apparent upon review of the following specification in conjunction with the drawings.

### BRIEF DESCRIPTION OF THE DRAWINGS

FIG. 1 is a top plan view of a conveyor system useful with the present invention;

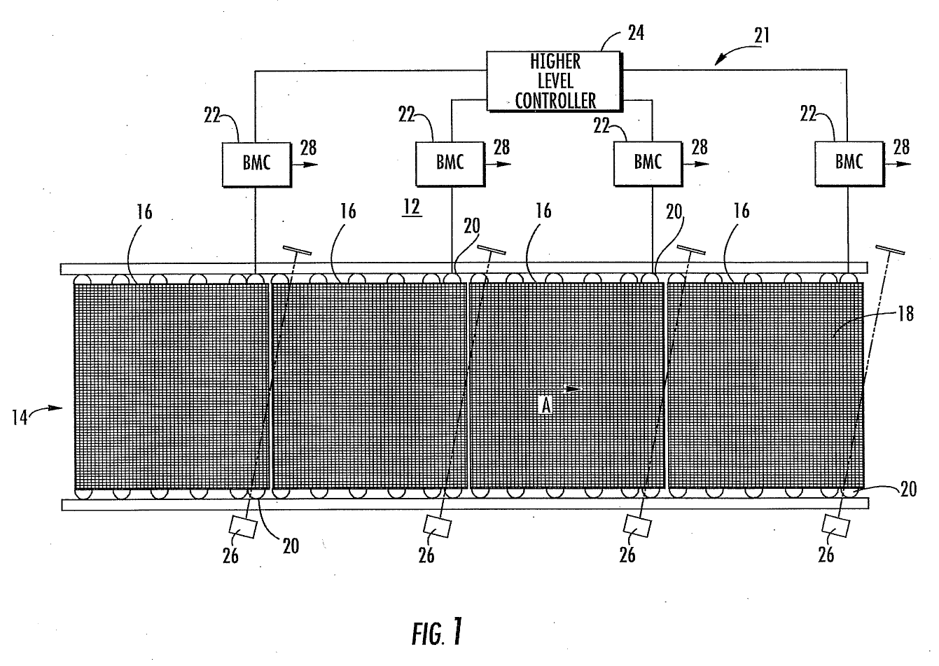

FIG. 2 is a block diagram of a dynamic gapping method according to the invention;

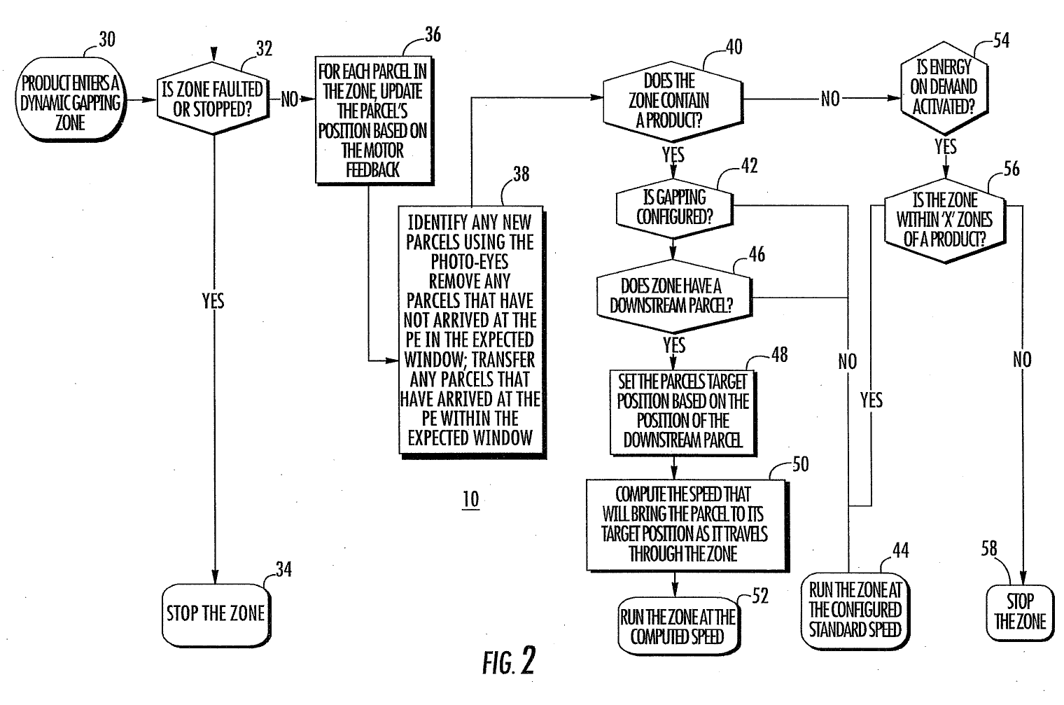

FIG. 3 is an illustration of operation of a dynamic gapping method;

FIG. 4 is an illustration of a known transportation technique;

FIG. 5 is an illustration of a known zero pressure accumulation technique;

FIG. 6 is an illustration of a known zero gap accumulation technique;

FIG. 7 is an illustration of a known traditional accumulation technique; and

FIG. 8 is a key to symbols used in FIGS. 3 through 7.

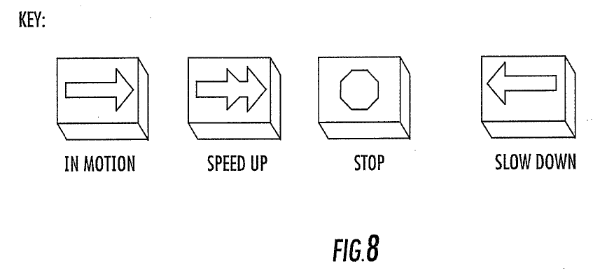

### DESCRIPTION OF THE PREFERRED EMBODIMENT

Referring now specifically to the drawings, and the illustrative embodiments depicted therein, a method of accumulation 10 is performed in the illustrative embodiment utilizing a belt conveyor system of the type disclosed in commonly assigned U.S. Pat. No. 6,811,018, the disclosure of which is hereby incorporated herein by reference. The details of the conveyor system is set forth therein in detail and will not be repeated herein. Suffice it to say, a conveyor system 12 includes a conveying surface 14 defined by a plurality of tandem zones 16 and a control system 21 for controlling movement of conveying surface 14. Each zone includes an endless belt 18 and a motor driven roller 20 for rotating the belt. In the illustrative embodiment, motor driven roller 20 may be a motorized roller of the type in which the motor assembly, or cartridge, is positioned entirely within the cylinder defining the roller. Such motorized roller is known in the art and is driven with a brushless motor controller 22, which forms a portion of control system 21. Brushless motor controller 22 may be of the type disclosed in commonly assigned Published Patent Application No. WO 06/017617 A2, the disclosure of which is hereby incorporated herein by reference. Control system 21 may further include one or more higher level controllers 24 in communication with a particular number of brushless motor controllers 22 for coordinating the corresponding zones. The higher level controllers may, in turn, be controlled by yet a higher level of control, such as a system level of control as disclosed in commonly assigned U.S. Pat. No. 7,035,714, the disclosure of which is hereby incorporated herein by reference. Each zone additionally includes an article sensor 26, such as a photo eye, sensing roller, proximity detector, or the like. While the invention is illustrated utilizing zones made up of endless belts that define the conveying surface, the endless belts may also be a tape drive of the type disclosed in commonly assigned U.S. Pat. No. 6,899,219, the disclosure of which is hereby incorporated herein by reference. Also, the invention may be carried out with conveyor systems having other hardware and control configurations.

As is known in the art, a motorized roller is driven by electronically commutated signals that are produced, in part, from feedback signals developed by sensors, such as Hall-effect sensors, within the motorized roller. In the illustrative embodiment, the control system utilizes such feedback signals developed by the motorized roller as a position signal that is proportional to movement of the endless belt 18. The control system also is responsive to signals produced by the article sensors 26 in order to track articles in the zones.

Method of accumulation 10 begins at 30 by an article entering a dynamic gapping zone 16, which is defined in the illustrative embodiment as one belt 18 and including one article sensor 26. It is first determined at 32 whether the zone is faulted or stopped. A zone is faulted, for example, if a jam has occurred, a hardware failure has occurred, or the like. If the zone is faulted at 32, it is stopped at 34. If the zone is not faulted, the article's position is updated for every article in that zone at 36 based on motor feedback utilizing positional signal 38 in order to track the articles based upon anticipated, or estimated, or expected position of the articles. Control system 21 utilizes positional signal 28 in order to develop the anticipated position of each article based upon movement of the conveying surface.

When an article enters a new zone at 38, article sensor 26 identifies that article. If an article, as identified previously and tracked by its anticipated position at 36 has not arrived at the article sensor at that zone within an expected window of time, the article is removed from the list of articles in the system as will be discussed in more detail below. This, for example, can occur if a jam should arise or if an article is manually removed from the conveyor system as will be discussed in more detail below. If it is determined at 38 that the actual arrival of that article at that zone is within the window of anticipated arrival of the article at that zone, the anticipated position of that article is updated as a function of the output of the article sensor.

Next, the method establishes a target position of that article as a function of the actual position of an article downstream of that article in the direction of article flow. This is accomplished by determining at 40 whether that zone contains an article. If so, it is determined at 42 whether a gapping function is configured. If the gapping function is not configured at 42, the zone is run at a standard speed at 44. This may occur, for example, if it is desired to track articles through one or more zones without necessarily adjusting the gap between articles. If gapping is configured at 42, it is then determined at 46 whether the adjacent downstream zone contains an article. If not, the upstream zone runs at the standard or nominal speed at 44. If the downstream zone includes an article, a target position of the upstream article is set based on the position of the downstream article at 48. The gapping is performed at the interface of adjacent upstream/downstream zones. The speeds of the adjacent zones are kept the same while the article is being transferred from one zone to the next. The change in control of article movement from one zone to the next may be based upon the leading edge or trailing edge of the article being transferred, or by some intermediate point between the leading and trailing edges, such as the control point of the article as disclosed in commonly assigned U.S. Pat. No. 6,629,593, the disclosure of which is hereby incorporated herein by reference.

In the illustrative embodiment, the gap between the upstream article and the downstream article may be adjusted according to various different parameters, known as “dynamic gapping.” The gapping may take place based upon different parameters of the article. For example, the gapping may be based upon distance between the leading edge of the downstream article and the leading edge of the upstream article, also known as “pitch gapping.” Alternatively, the gapping may take place based upon distance between the trailing edge of the downstream article and the leading edge of the upstream article, also known as “window gapping.” Alternatively, the gap may be obtained from a gap table based upon, for example, length of one or more of the articles, or the like. Such configurable gap is particularly useful in sortation applications. Once the target position of the upstream article is set at 48, the speed of the zone that will bring that article to its target position as it travels to that zone is computed at 50 and carried out at 52. The speed is computed in a continuum between a maximum speed and a minimum speed.

If it is determined at 40 that a zone does not contain an article, it is determined at 54 whether the system “Energy On Demand” feature is activated. The Energy On Demand feature causes the conveying surface to be operated only when necessary. If the Energy On Demand feature is activated at 54, it is determined at 56 whether the particular zone of interest is within a particular number of zones of an article within the system. The particular number of zones may be fixed or configurable. If the configured number of zones is, for example, five zones, it is determined whether there is an article either within five zones upstream or five zones downstream of the particular zone of interest. If there is not an article in the configured number of zones upstream or downstream of the zone of interest, the zone of interest is stopped at 58.

Thus, the Energy On Demand is based upon the system's knowledge of where articles are located so that unused motors can be turned off. In addition, when a zone is stopped, the rate of acceleration of that zone may be increased such that, when the zone is later caused to “awake” by an article approaching that zone, the conveying surface may rapidly accelerate in order to accommodate dynamic gapping of that article. Thus, in the present system, the Energy On Demand feature is based upon the anticipated position of the articles, which, in turn, is based upon the position of the conveying surface and does not require the use of timers, or the like.

Each article in the system may include a data structure associated with that article. The data structure defines a logical article that coincides with the physical article. The logical article is associated with the anticipated position of the physical article. If the physical article does not arrive at the article sensor of a particular zone within a particular window of time of the anticipated arrival of the logical article, the data structure for that article is deleted from the system. This allows the system to accommodate the removal of articles from the system, such as by manual removal, or the like. Also, the logical article data structure is updated in order to remove drift from the anticipated position of the article every time the physical article passes an article sensor. This maintains accuracy of the anticipated position of the logical article. The data structure associated with each article may include, by way of example, the weight, height and width of the article as well as a code field, such as a 120 byte barcode or radio frequency identification code that accompanies the article. For example, each article may support a barcode or an RFID tag which is listed in its data structure. Also, one or more article identification numbers may be assigned to each article and is included in the data structure. The use of a data structure defining a logical article provides traceability of each article as it travels through the system as well as accommodates the removal of articles, such as manually, from the system. Also, it provides accuracy by updating the logical data according to the physical article position whenever the physical article is detected by an article sensor. The accurate position of the article is used in determining a target position of the article in order to provide accurate gapping of the article with respect to adjacent articles.

When an article is being transferred from one zone to the next, a message is sent to the downstream zone indicating the nature of the transfer. Because the dynamic gapping method 10 only modifies gaps for articles that are on an individual zone, the zone can receive external commands over a network to target individual articles for specialized treatment. This allows multiple zones to be operated as one zone in order to handle larger articles that are transported by more than one zone at a time. Also, the method accommodates multiple articles within one zone in the manner that would be apparent to the skilled artisan. The communication between adjacent zones may be accomplished utilizing the techniques disclosed in commonly assigned U.S. patent application Ser. No. 60/746,901 filed May 10, 2006, entitled DYNAMIC MOTORIZED ROLLER CONVEYOR CONTROL, by Pelak et al., the disclosure of which is hereby incorporated herein by reference.

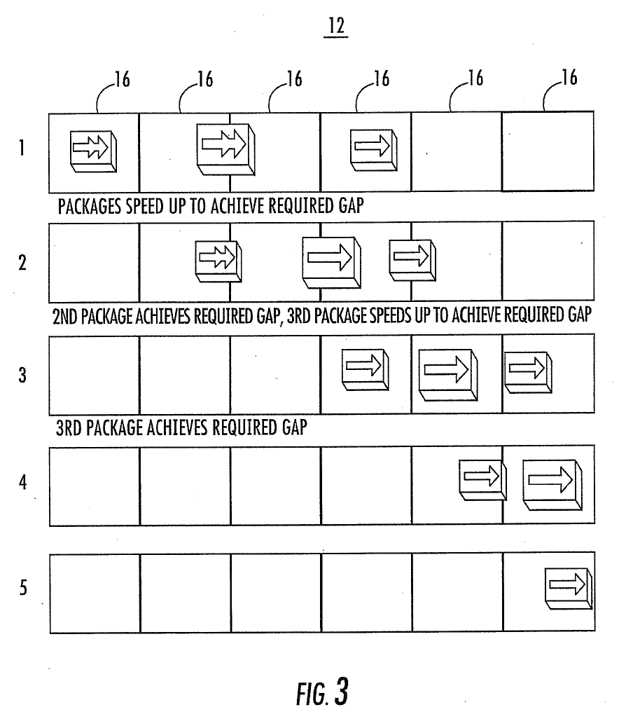

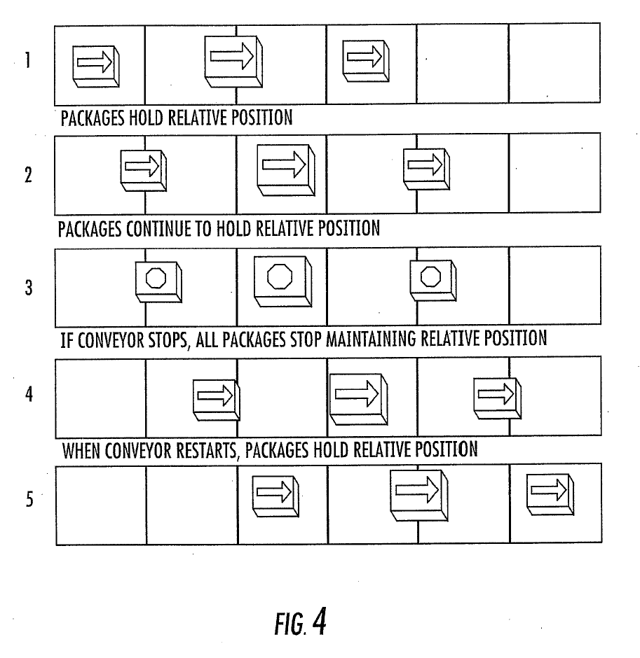

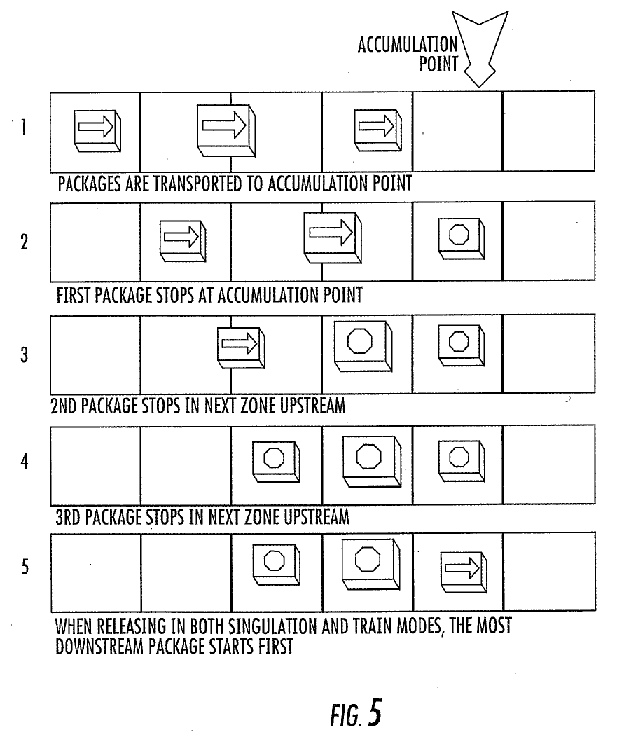

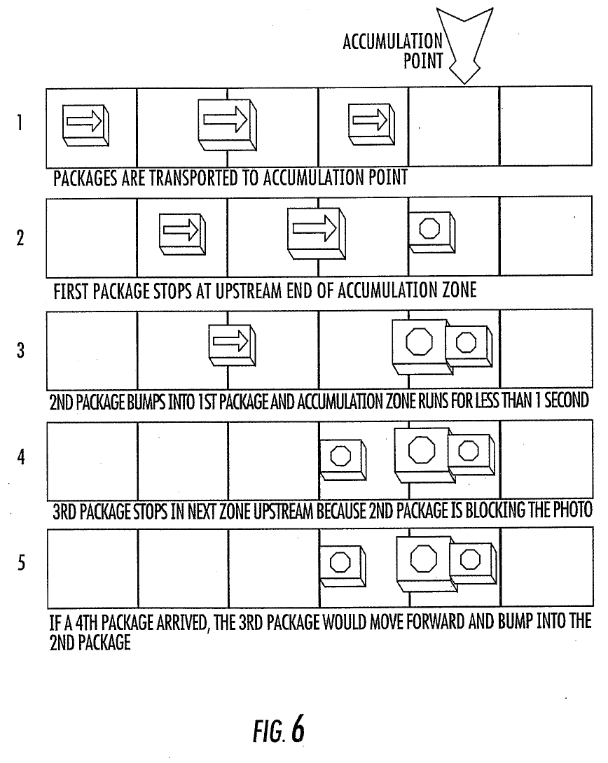

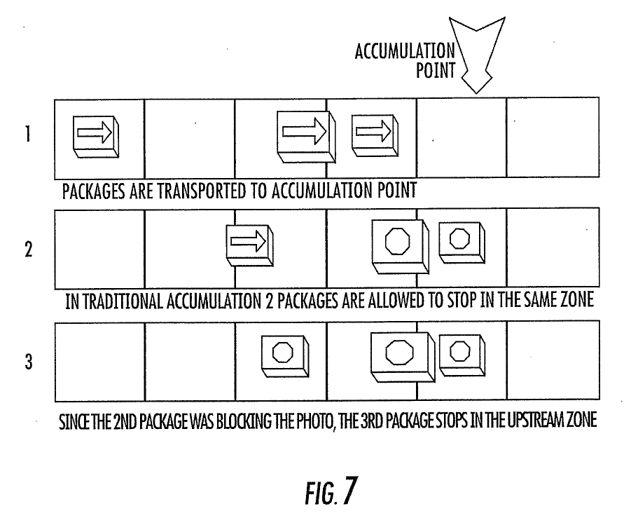

FIG. 3 illustrates movement of articles using the illustrated dynamic gapping method. As can be seen, articles are either in motion at their present speed or accelerated to a higher speed. The articles are gapped without decelerating or stopping the articles. In contrast, known conveying techniques illustrated in FIGS. 4-7 do not adjust gaps between articles without slowing or stopping the articles.

In the illustrative embodiment, each zone is approximately one-half meter in length. Method 10 allows the dynamic setting of gaps between articles without the necessity of stopping one or more of the zones in order to build a slug, if desired. The gaps may be adjusted on-the-fly by the control system 21 anywhere between a zero length gap and a particular finite length gap. This allows zero gap accumulation, for example, for takeaway spurs from a sortation system. Alternatively, finite gaps may be established, for example, in order to replace the induction function that establishes controlled gaps between articles being fed to a sortation system. However, the accumulation and gapping formation may take place throughout the entire transportation system, if desired, thereby allowing an enhanced throughput to the system. This may be accomplished without any specialized equipment provided for the accumulation function. Also, the accumulation may take place on belt conveyors thereby facilitating the handling of a wide range of physical article configurations may not be compatible with roller-type conveyor systems. Also, unlike prior accumulation systems, the identity of each article may be tracked throughout the system and utilized to accurately determine the position of that article with respect to adjacent articles. The anticipated position of each article is tracked utilizing feedback determined from each motorized roller 20 and is updated to remove drift from the anticipated position of the article when the real, or actual, position of the article is determined at an article sensor. By allowing excessive gaps to be removed from between articles without the necessity of stopping the articles, the throughput of the system may be increased. Moreover, the length of gaps and type of gaps may be set differently in different parts of the system and may be modified on-the-fly, according to, for example, different times of operation or different operational conditions.

Thus, it is seen that the present invention provides a unique method of transporting and accumulating articles, such as into slugs, by utilizing common low-cost components to perform functions presently performed by specialized components. This may accomplished without the necessity for stopping the articles to form slugs. Gaps may be formed between articles irrespective of article size.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A slug-building conveyor system, comprising:
a conveying surface defined by a plurality of tandem zones, each of said zones including an article sensor and a position encoder, said position encoder adapted to producing a position signal proportional to movement of articles in that zone, said article sensor adapted to sensing articles in that zone; and
a control responsive to said position signals and to said article sensors for tracking articles in said zones;
wherein said control is adapted to establish a target position for an article in one of said zones as a function of a position of an article downstream of that article in the direction of article flow and to adjust the speed of said one of said zones to bring that article toward its target position such that gaps between articles are adjusted during transportation of the articles.

2. The system as claimed in claim 1 wherein each of said zones includes an endless belt and a motor driven roller, said motor driven roller driving said belt.

3. The system as claimed in claim 2 wherein said position signal is proportional to movement to said belt in that zone.

4. The system as claimed in claim 2 wherein said control is adapted to control the speed of at least one of said belts to bring an article to its target position as it travels through the corresponding zone.

5. The system as claimed in claim 1 wherein said gaps between articles are selected from pitch gaps, window gaps or configurable gaps.

6. The system as claimed in claim 1 wherein said control defines a data set for each article on said conveying surface.

7. The system as claimed in claim 6 wherein said control deletes the data set for an article when that article does not arrive at a zone within an anticipated interval.

8. The system as claimed in claim 6 wherein said data set includes at least one chosen from i) article weight, ii) article width, iii) article identification, iv) barcode, and v) radio frequency identification code.

9. The system as claimed in claim 2 wherein said motor driven roller comprises a motorized roller.

10. The system as claimed in claim 9 wherein said motor driven roller defines said encoder.

11. The system as claimed in claim 10 wherein said motorized roller includes rotational position sensors used for application of electrical power to rotate said motorized roller and wherein said control obtains said position signal from said rotational position sensors.

12. The system as claimed in claim 1 wherein said endless belt defines a portion of said conveying surface.

13. A slug-building conveyor system, comprising:
a conveying surface defined by a plurality of tandem zones, each of said zones including an article sensor and a position encoder, said position encoder adapted to producing a position signal proportional to movement of articles in that zone, said article sensor adapted to sensing articles in that zone; and
a control responsive to said position signals and to said article sensors for tracking articles in said zones;
wherein said control is adapted to determine anticipated positions of articles on said conveying surface as a function of at least one of said position signals, wherein said control is adapted to determine an actual arrival of an article at one of said zones as a function of said article sensor for said one of said zones sensing that article;
wherein said control is adapted to determine an anticipated arrival of that article at said one of said zones as a function of the anticipated position of that article and to compare the actual arrival of that article at said one of said zones with the anticipated arrival of that article at said one of said zones and to update the anticipated position of that article as a function of said comparing;
wherein said control is adapted to establish a target position for that article as a function of a position of an article downstream of that article in the direction of article flow and to adjust the speed of said one of said zones to bring that article toward its target position.

14. The system as claimed in claim 13 wherein each of said zones includes an endless belt and a motor driven roller, said motor driven roller driving said belt.

15. The system as claimed in claim 14 wherein said position signal is proportional to movement to said belt in that zone.

16. The system as claimed in claim 14 wherein said control is adapted to control the speed of at least one of said belts to bring an article toward its target position as it travels through said one of said zones.

17. The system as claimed in claim 13 wherein said control is adapted to adjust the target position of that article such that gaps between articles can be dynamically adjusted.

18. The system as claimed in claim 17 wherein said gaps between articles are selected from pitch gaps, window gaps or configurable gaps.

19. The system as claimed in claim 13 wherein said control defines a data set for each article on said conveying surface.

20. The system as claimed in claim 19 wherein said control deletes the data set for an article when the actual arrival of that article at a zone does not occur within a particular period after the anticipated arrival of that article at that zone.

21. The system as claimed in claim 19 wherein said data set includes at least one chosen from i) article weight, ii) article width, iii) article identification, iv) barcode, and v) radio frequency identification code.

22. The system as claimed in claim 14 wherein said motor driven roller comprises a motorized roller.

23. The system as claimed in claim 22 wherein said motor driven roller defines said encoder.

24. The system as claimed in claim 23 wherein said motorized roller includes rotational position sensors used for application of electrical power to rotate said motorized roller and wherein said control obtains said position signal from said rotational position sensors.

25. The system as claimed in claim 13 wherein said endless belt defines a portion of said conveying surface.

26. A method of building slugs of articles, comprising:
providing a conveying surface defined by a plurality of tandem zones, each of said zones including an article sensor and a position encoder;
producing a position signal with said position encoder, said position signal proportional to movement of articles in that zone;
sensing articles in a zone with said article sensor;
establishing a target position for an article in one of said zones as a function of a position of an article downstream of that article in the direction of article flow; and
adjusting the speed of said one of said zones to bring that article toward its target position such that gaps between articles are adjusted during transportation of the articles.

27. A method of building slugs of articles, comprising:
providing a conveying surface defined by a plurality of tandem zones, each of said zones including an article sensor and a position encoder;
producing a position signal with said position encoder, said position signal proportional to movement of articles in that zone;
sensing articles in a zone with said article sensor;
determining anticipated positions of articles on the conveying surface as a function of at least one of said position signals;
determining an actual arrival of an article at one of said zones as a function of said article sensor for that zone sensing that article;
determining an anticipated arrival of that article at said one of said zones as a function of the anticipated position of that article;
comparing the actual arrival of that article at said one of said zones with the anticipated arrival of that article at said one of said zones and updating the anticipated position of that article as a function of said comparing;
establishing a target position for that article as a function of a position of an article downstream of that article in the direction of article flow; and
adjusting the speed of said one of said zones to bring that article toward its target position.
